(19) United States
(12) Patent Application Publication
(10) Pub. No.: US 2013/0090949 A1
(43) Pub. Date: Apr. 11, 2013

(54) THERAPY MANAGEMENT, COMMUNICATION AND INTERACTION SYSTEM

(71) Applicant: Solome Tibebu, Minneapolis, MN (US)

(72) Inventor: Solome Tibebu, Minneapolis, MN (US)

(21) Appl. No.: 13/649,868

(22) Filed: Oct. 11, 2012

Related U.S. Application Data
(60) Provisional application No. 61/545,888, filed on Oct. 11, 2011.

(51) Int. Cl. G06Q 50/24

(52) U.S. Cl. 705/3

(57) ABSTRACT

The present disclosure relates to a computerized system which provides a patient/client treatment management tool, with communication capability, patient therapy assignment and tracking, and game-oriented content and function, as well as an analytics platform for care providers. The present disclosure is unlimited in regard to what type of mental health care provider or other counselor may benefit from the use of the system disclosed herein, and the system is intended to be used by any person providing, managing or receiving mental health counseling or treatment.

### CROSS-REFERENCE TO RELATED APPLICATION

This application claims the benefit of U.S. Provisional Application Ser. No. 61/545,888, titled THERAPY MANAGEMENT, COMMUNICATION AND INTERACTION SYSTEM, filed Oct. 11, 2011.

### BACKGROUND OF THE INVENTION

Psychotherapists and other mental health care providers and counselors spend hours with anxious and depressed clients and patients, trying to understand them and then teach them how to deal with their anxiety, depression and other mental health-related issues. The feedback they often get from their misunderstood and/or confused patients and/or angry, helpless parents or other caregivers shows that the therapists may not be helping their clients and patients effectively and therefore must deal with more toil, paperwork and lengthy written communications from patients than is optimal. They may spend so much time doing this in ineffective ways, week after week, that patients, parents and caregivers can become frustrated.

### BRIEF SUMMARY OF THE INVENTION

The present disclosure relates to a computerized system that could make non-clinical and clinical tasks easier for therapists, counselors or other care providers and make treatment more fun and responsive for patients, thereby making therapy more effective and increasing patient satisfaction. The disclosed system provides a patient/client treatment management tool, with communication capability, patient therapy assignment and tracking, and game-oriented content and function, as well as an analytics platform for care providers. The present disclosure is not intended to be limiting in regard to what type of mental health care provider or other counselor may benefit from the use of the system disclosed herein, and the system is intended to be used by any person providing, managing or receiving mental health counseling or treatment.

### BRIEF DESCRIPTION OF THE DRAWINGS

FIG. 1 is an example graphical user interface according to one embodiment of the present invention.

FIG. 2 is an example graphical user interface according to one embodiment of the present invention.

FIG. 3 is an example graphical user interface according to one embodiment of the present invention.

FIG. 4 is an example graphical user interface according to one embodiment of the present invention.

FIG. 5 is an example graphical user interface according to one embodiment of the present invention.

FIG. 6 is an example graphical user interface according to one embodiment of the present invention.

FIG. 7 is an example graphical user interface according to one embodiment of the present invention.

FIG. 8 is an example graphical user interface according to one embodiment of the present invention.

FIG. 9 is an example graphical user interface according to one embodiment of the present invention.

FIG. 10 is an example graphical user interface according to one embodiment of the present invention.

FIG. 11 is an example graphical user interface according to one embodiment of the present invention.

FIG. 12 is an example graphical user interface according to one embodiment of the present invention.

FIG. 13 is a flow chart illustrating the homework or exercise assignment and completion process according to one embodiment of the present invention.

FIG. 14 is a flow chart illustrating the process whereby games or exercises may be triggered automatically according to certain conditions, according to one embodiment of the present invention.

FIG. 15 is a schematic block diagram of an example computing system.

### DETAILED DESCRIPTION

Various user interfaces and embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims. It is understood that various omissions and substitutions of equivalents are contemplated as circumstances may suggest or render expedient, but these are intended to cover applications or embodiments without departing from the spirit or scope of the claims attached hereto. Also, it is to be understood that the phraseology and terminology used herein are for the purpose of description and should not be regarded as limiting.

For persons, especially youth, suffering from panic disorder, obsessive compulsive disorder, social phobia, and other anxiety disorders, the disclosed system offers benefits in an effective, immediate and calming way by providing computer games and mental health homework or exercises that incorporate game mechanics to make the homework fun, challenging, and engaging. With the opportunity to do the homework at their own convenience, patients are getting more consistent, continuous and effective treatment. Cognitive behavioral therapy and mindfulness techniques are intertwined in the applications, allowing patients to do their homework through game-like engagement. In some embodiments, the disclosed system may be in the form of a mobile application to provide convenience and allow a patient to accurately input what he or she is feeling at his or her exact moments of stress in various environments and locations. This helps further enhance the ability to provide immediate anxiety relief, wherever the patient is and whenever they need it, with real-time feedback to the therapist.

The disclosed system can make the job of the psychotherapist or care provider much easier by collecting real-time feedback from patients' game results and automatically sending the data to the therapist. This provides a more accurate overall picture of what the patient is experiencing during the time the care provider and the patient are apart, thus helping create a greater understanding of the individual and providing the ability to offer much better treatment. The disclosed system facilitates a significantly stronger connection between patients and care providers at all times.

The system allows important analytics to be automatically sent in real time to the therapist or care provider, such as date and time of panic attack, feelings, thoughts and emotions at that time, location of the patient through an integrated GPS system, and more. Thus, the therapist can plot the times and locations where the patient is most susceptible to panic attacks or other mental health episodes. Further, with the availability of real-time feedback, therapists could, in an emergency situation, intervene or communicate with the patient in an effort to provide timely counseling or aid.

In addition, the system could be programmed to learn automatically where and when panic or other anxiety attacks occur and use such information to present mental health information, therapeutic reminders and interactions and/or game suggestions to prevent such attacks from occurring. A given patient may experience anxiety in schools, large or enclosed public settings, or particular address locations, or at certain times of day (prior to sleep, for example), and the system would react in advance to attempt to re-direct the patient from possible attack.

Further, a native application could monitor other smart phone or PC usage to look for indicia of distress or potential distress. For example, the system could evaluate the identities of persons being emailed or text messaged that have been previously associated (by time or location) with potential patient anxiety issues and introduce an interrupt that re-directs the patient to an interactive mindfulness session or interactive feature. This could be further enhanced to evaluate the use of certain terms in email, text messages or social networks that may indicate social or psychological distress (for example, obscenities, derogatory language, or threat of violence to third parties or themselves,). The same interrupt or re-direction could be programmed to occur in such instances.

The system disclosed herein may provide the ability to streamline much of the non-clinical hassles of therapists or care providers. For example, patient progress can be presented in a much more organized and user-friendly format in a patient profile/calendar set-up, and integrated with the patient's current psych-specific electronic health records. The system integrates into the current medical record-keeping systems of care providers and reduces the amount of workflow they need to manage. Further, with the real-time homework and patient interaction data, therapists are better able to deliver care when the patient returns for therapy. The provider interface includes the ability to view patient interactions, enter review of therapy sessions, assign homework which is then visible in client/patient interface, view summary results of patient homework and provide a custom-designed patient questionnaire to keep a client's records up to date, among other functions.

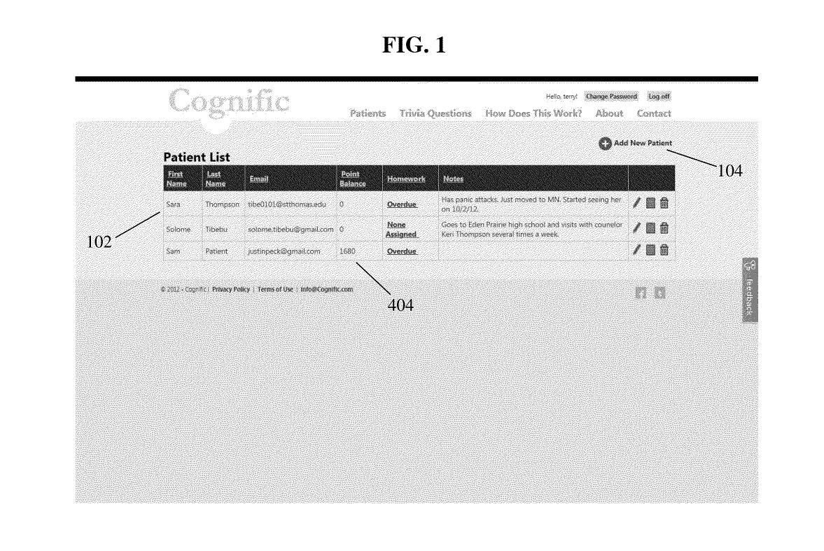

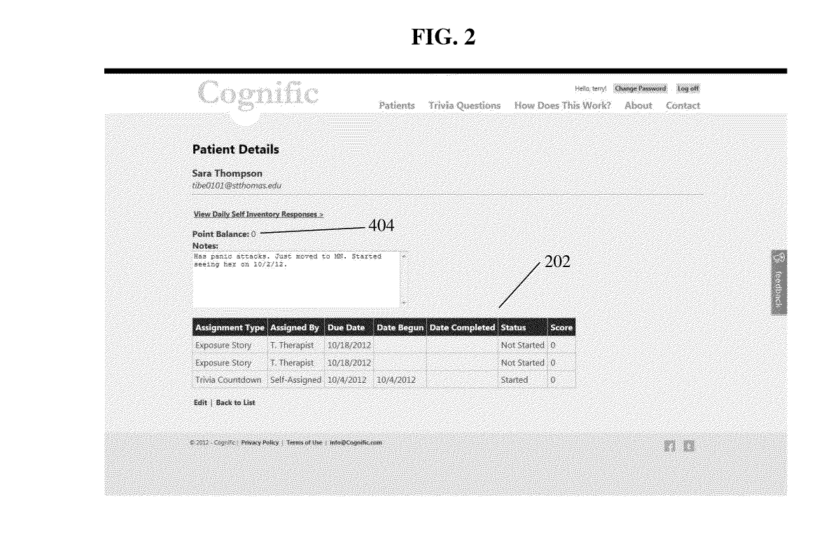

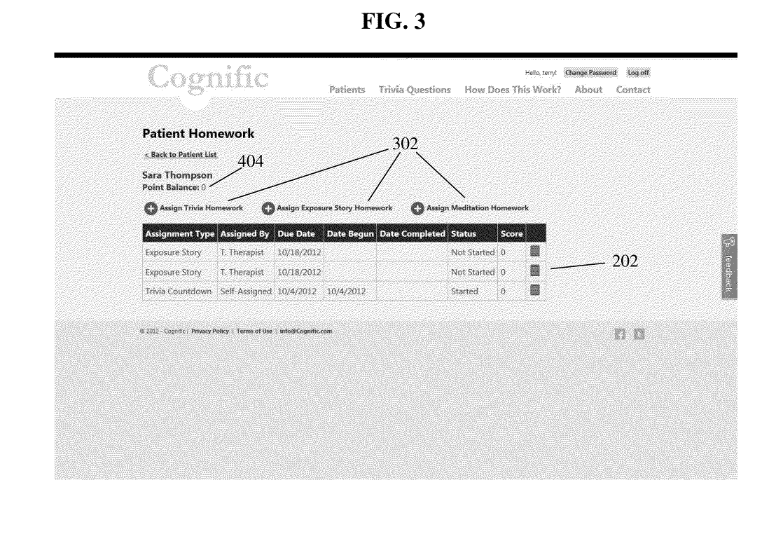

FIG. 1 illustrates one example of a patient list 102 within the disclosed system accessible by a therapist or care provider. The patient list 102 may include a summary of all of the care provider's patients, and may include information such as the status of each patient's homework, each patient's point balance (described in more detail below) and care provider notes, among other things. Care providers can use the patient list interface to add a new patient (104). The care provider may also view details about a specific patient from their patient list, as illustrated in FIG. 2, by selecting a patient from patient list 102. The patient details interface may show information such as patient contact information and the status of specific homework assignments, as well as a patient homework assignments list 202, and may allow the care provider to edit patient information or add notes regarding the specific patient. Care providers also have the ability to view more information about patient homework, as illustrated in FIG. 3. In this example patient homework interface, the care provider has the option to view homework status and scores, among other information. The patient homework interface may also include a view of patient homework assignments list 202. Further, the care provider is able to assign homework or exercises to their patients (302).

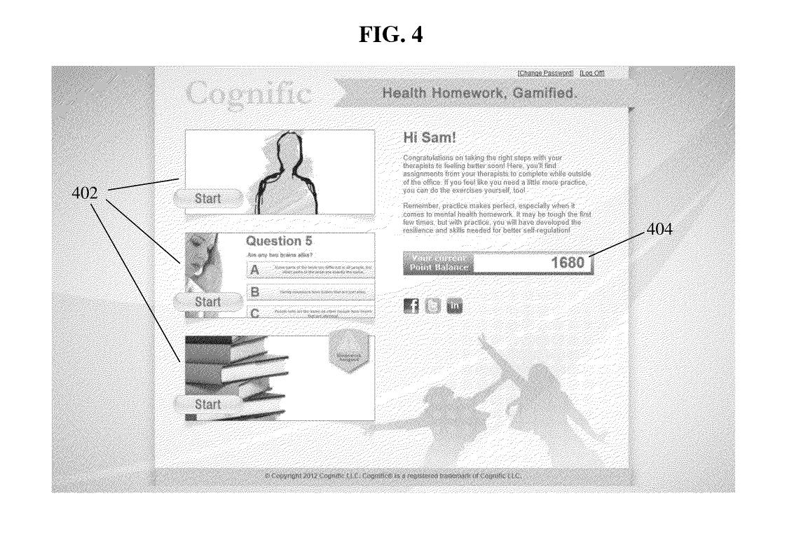

After a care provider has assigned homework to a remote patient user, the assigned homework will appear on the patient user interface. FIG. 4 shows an example home screen which appears when a patient user has accessed the system. In this example, the care provider has assigned three homework assignments to the patient, links (402) to which are available on the left side of the example patient interface shown in FIG. 4. A patient receives points for completing homework assigned by their therapist; a patient's point balance 404 can be viewed by the care provider, as illustrated in FIGS. 1, 2 and 3, or by the patient as illustrated in FIG. 4.

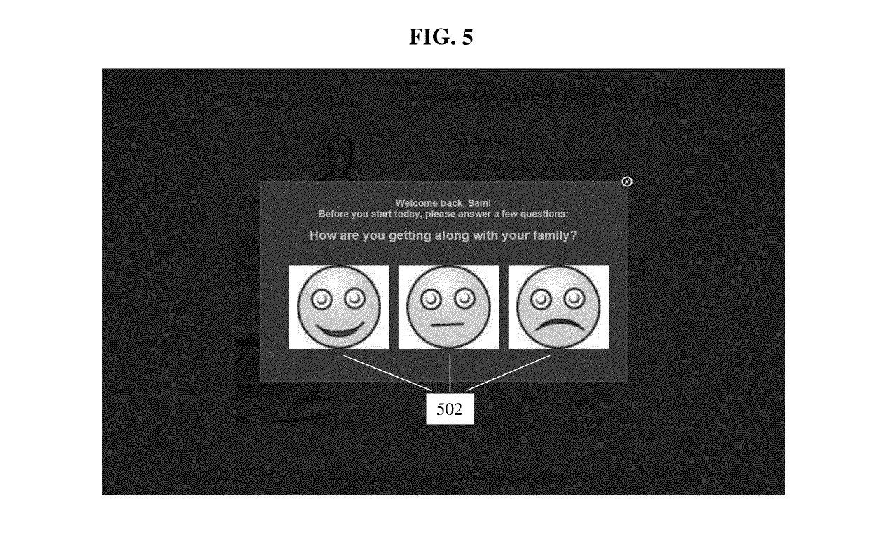

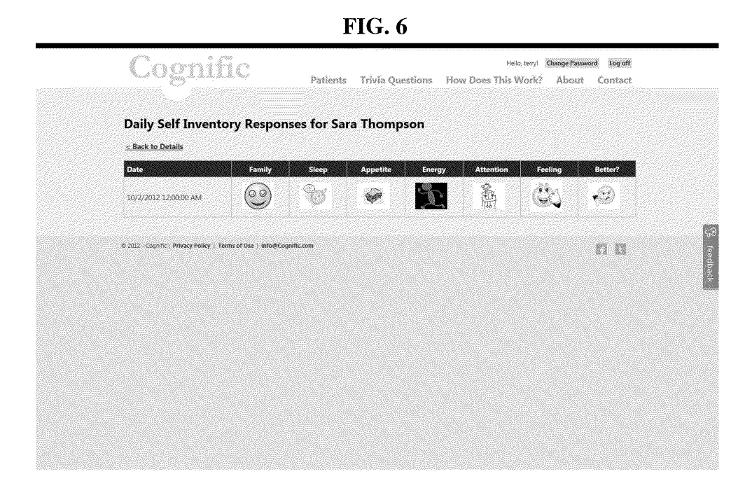

The disclosed system includes a patient self inventory questionnaire that must be completed by the patient user upon login. In some embodiments, a patient is asked at different times of day to complete this questionnaire. An example of this questionnaire is illustrated in FIG. 5. The questionnaire is a series of questions that may relate to the patient's mood, family interaction, sleep habits, appetite, or anything else about the patient that may indicate their mental state at a given time. In some embodiments, the patient responds to the questionnaire using visual indicators 502, as shown in FIG. 5. As the patient user completes this questionnaire, or upon completion of the questionnaire, their responses are sent to a remote care provider and stored within the care provider's patient information, as illustrated in FIG. 6. The results may be date and time stamped to indicate when the questionnaire was completed. The results may also indicate the location of the patient user when the questionnaire was completed.

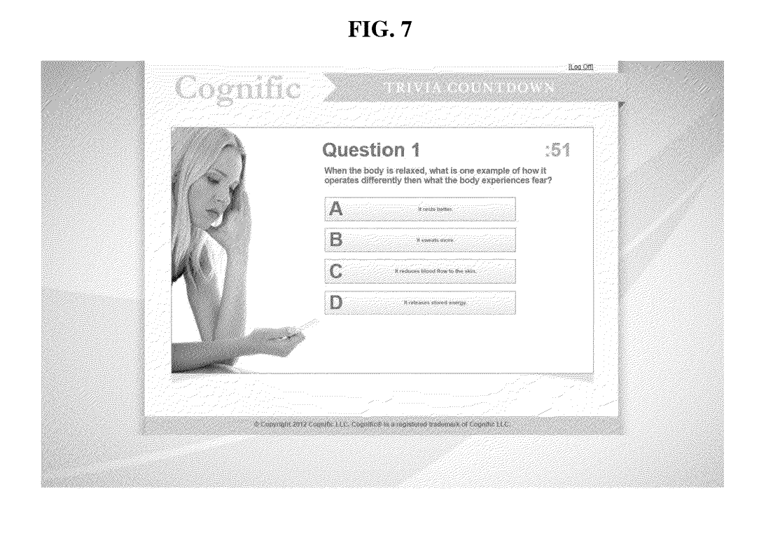

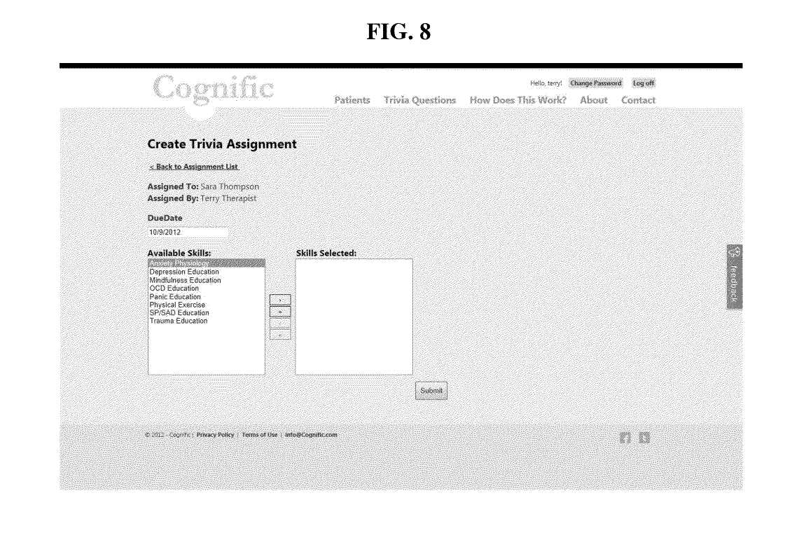

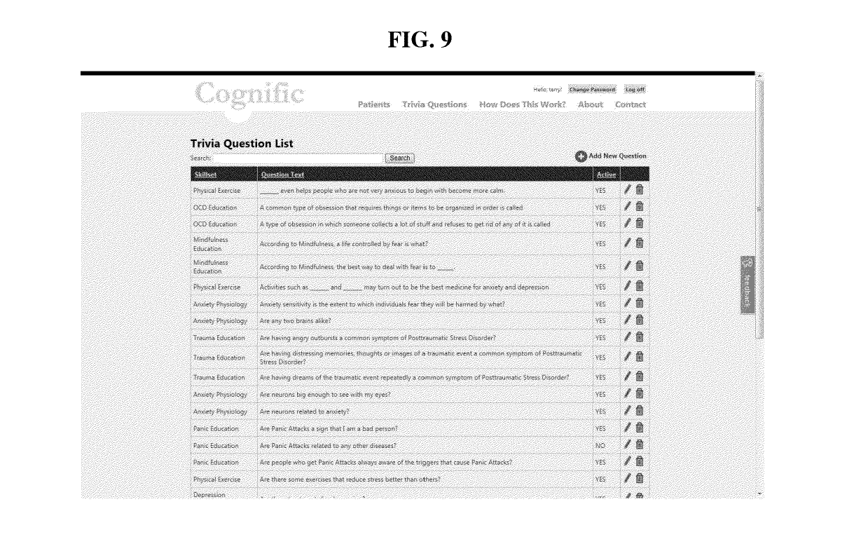

FIG. 7 is an example of one of the patient games included in the disclosed system. This is a fast-paced question and answer game where, after the patient has submitted his/her disorder questionnaire to the software after creating his/her profile, the game will focus its content to the patient's specific disorder. In the example shown in FIG. 7, the care provider has assigned a category that contains questions related to a specific disorder or therapeautic skillset (see FIG. 8), such as panic disorder, nutrition or mindfulness, causing the game to focus on questions related to the topics chosen by the care provider for this particular patient. FIG. 9 illustrates one example of a list of trivia questions accessible by the care provider. The questions may be chosen by the care provider from a pre-loaded trivia question list, as shown in FIG. 9; as further illustrated in FIG. 9, psychotherapists or care providers have the ability to insert their own custom questions into the game. These questions may be relevant to what the patient and care provider discussed in their sessions together.

As questions are prompted at the top of the screen, the patient then needs to select the correct answer on the screen. At the end of each question, a learning opportunity is presented to the patient to ensure psychoeducation of their symptoms. Patients may also have the ability to play a particular level over again.

Specific questions in the game that are relevant for the therapist or care provider to know about his/her patient are sent back to the therapist's patient profile , with details such as date, time and location. The therapist can view which questions the patient guessed incorrectly, and which levels they made it through. The purpose of this game is both therapeutic and educational: patients learn more about their disorder (which helps them remove themselves from future anxious situations much more readily) as well as experience calm and distraction from a possible current troublesome situation as they play fun games that help themselves.

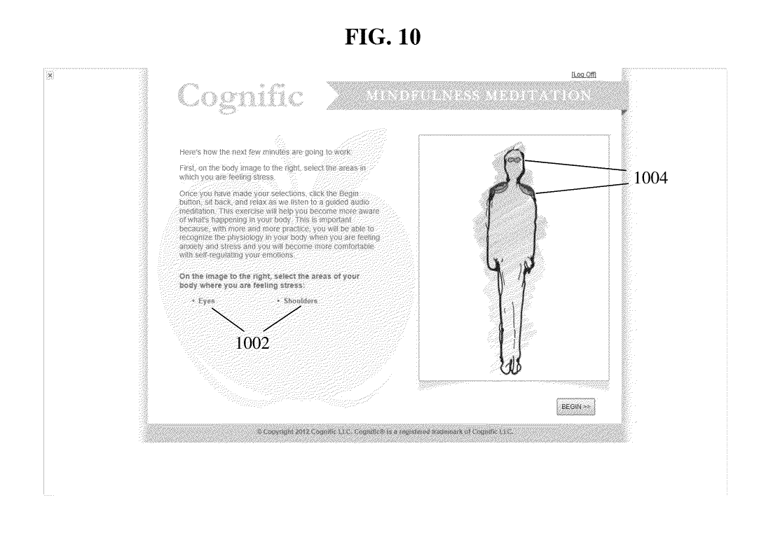

FIG. 10 ilustrates another example of a patient game included in the disclosed system, referred to herein as a mindfulness activity. In the mindfulness activity, patients are presented with an image of a human body, where they are to select areas where they feel tension at the present time or while they are in a panic attack. In the example illustrated in FIG. 10, the patient has selected eyes and shoulders; in this example, the selected body parts are listed on the screen (1002) and also indicated by shading (1004) on the human body image. Once the user selects areas of tension and submits their selections, the system will continue with an audio of guided muscle relaxation and meditiation, focusing longer on the areas that the patient has selected. Positive affirmations relevant to the user's disorder may be inserted throughout the guided relaxation audio. These specific affirmations may be based on the user's initial profile questionnaire; for example, if the patient described his/her symptoms to be Social Phobia in the preliminary profile questionnaire, then the mindfulness activity guided relaxation audio might include affirmations such as, “I believe in myself,” “I can control my anxiety,” etc. Additionally, therapists and patients may work together in the therapist's office to record their own voices to insert in the audio. This feature is only accessible in the therapist's administrative side of the site to ensure that audio is, in fact, positive, safe and effective when custom audio is included. Users have the ability to transport and download custom mp3s or other audio files to sync with the system's mobile application to allow users to listen to their mindfulness audio on-the-go.

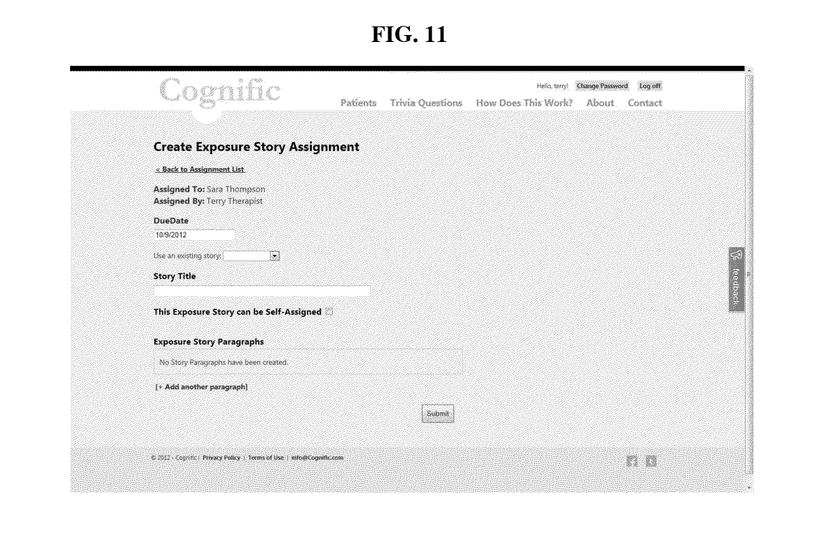

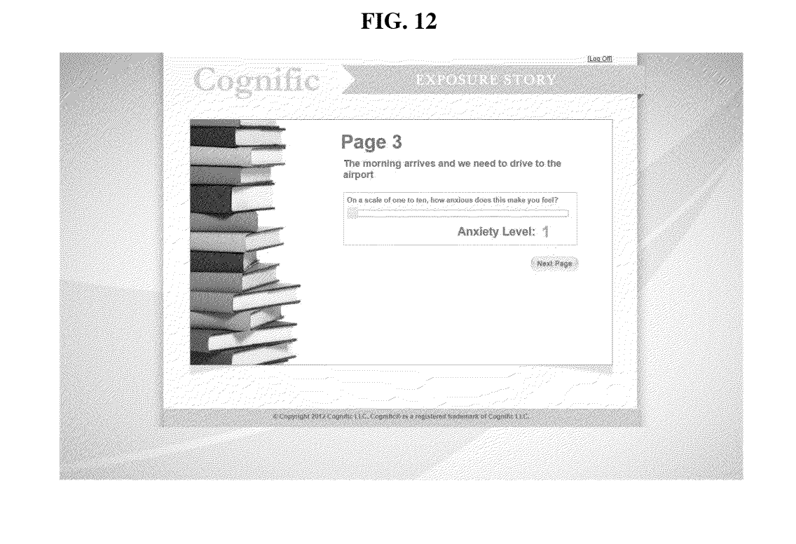

Another possible exercise or homework assignment available in the disclosed system is a module used for prolonged exposure therapy, exposure therapy practice, and other activities where the therapist assigns content to a patient and recieves ranked feedback in return. On the therapist's interface, an example of which is illustrated in FIG. 11, the patient and therapist write a narrative together about the patient's worst case scenario. The therapist may also write this narrative without the patient's assistance, based on knowledge the therapist has of the patient's situation. For example, they may title it “Fear of Flying” and write a descriptive story about the patient going on a flight. Once submitted, the patient may open the story on his/her interface, as illustrated in FIG. 12, and either practice visualizations of the narrative or actually do the exercise in real life and use the narrative as a guide. With each action in the story, patients are prompted to rank 1-10 what their level of fear or anxiety is. Once patients complete the review and ranking exercise, therapists can see which paragraphs caused the most amount of distress for the patient based on ranking scores. Further, specific narratives could be triggered by specific times, locations or social situations.

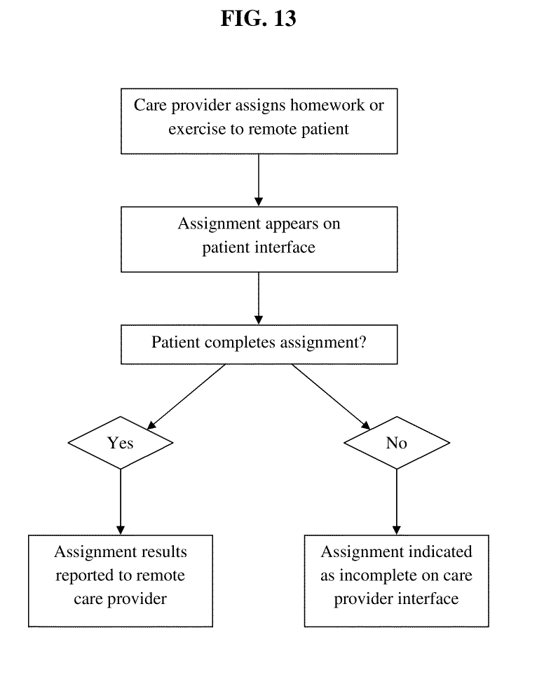

FIG. 13 is a flow chart depicting the process of homework or exercise assignment, completion and reporting back to the care provider. After a care provider assigns homework or an exercise to a patient, the assignment appears as a link on the patient's interface of the disclosed system, whether in the form of a computer application or mobile application, where the patient can access the assignment. The patient then either completes the assignment or does not complete the assignment. If the assignment is completed by the patient, the results are automatically reported to the remote care provider or other remote party. If the assignment is not completed by the patient, the incomplete status is indicated on the care provider interface (for example, the assignment may be marks as incomplete or overdue).

The system disclosed herein may be available in the form of a mobile application, which a patient may use to send additional feedback related to their current mental health status to their therapist or care provider. A patient may also use the mobile application to complete homework assignments or exercises as described above.

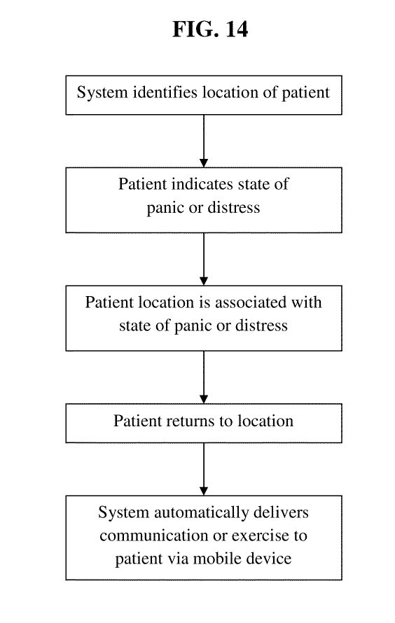

In some embodiments, games or exercises may be triggered automatically according to certain conditions. See FIG. 14 for a flow chart illustrating this process. An exercise or communication from a patient's caregiver or therapist may be triggered by a specified time or location where the patient has experienced panic or mental distress in the past. For example, if a patient has indicated that they have experienced panic or distress at a shopping mall in the past, and then later returns to the same shopping mall, the disclosed system would recognize the location of the patient using GPS or other location-capturing technology and a game or exercise would be automatically assigned or triggered by the system as a way to calm and distract the patient from their potential feelings of anxiety. As another example, if a patient has indicated that they experience panic or distress at 10:00 p.m., a game or exercise or communication from the patient's caregiver or therapist may be automatically triggered at this time. This automatic assignment of exercises or communication may be triggered by other indicators as well, such as derogatory language appearing in text messages or emails.

Games like those described above can be used as follow-up homework for patients or can be used as real-time therapy aids when a patient is having a mental health episode. Patient interaction with games will vary based on their needs and additional games or applications can be provided to patients purely as a spontaneous therapy tool. These games can be optimized or designed to take advantage of a smartphone touch interface. For example, an application could provide a combination of screen interactions and sound that are intended to calm down or focus a patient during an episode.

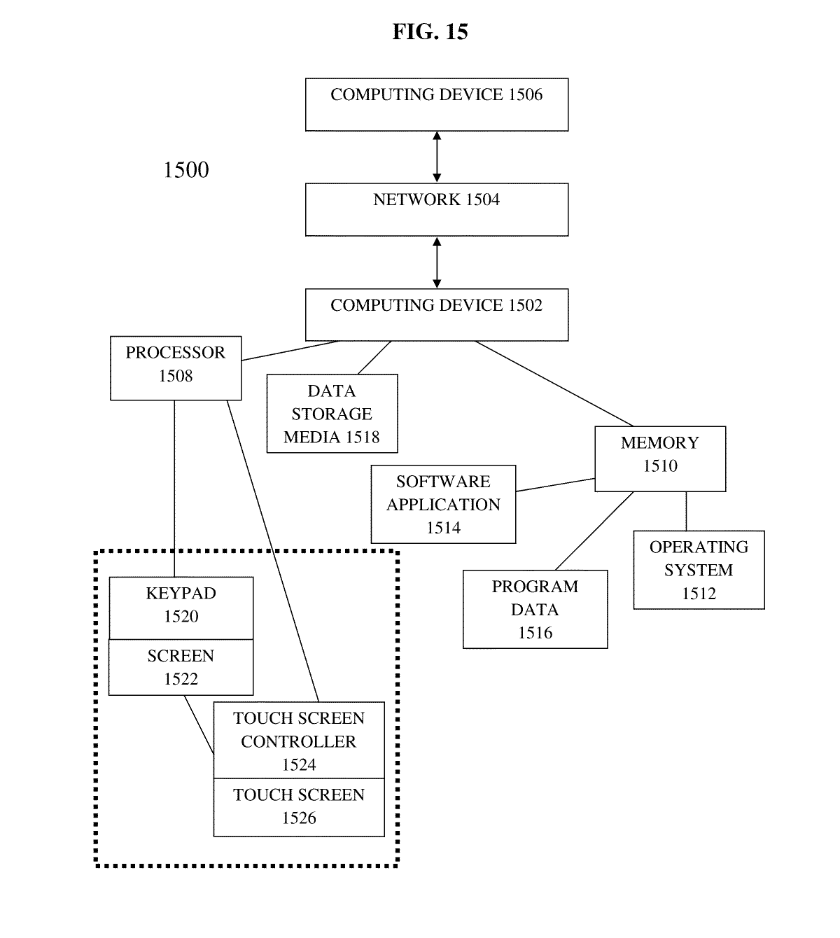

In general terms, the present disclosure relates to an online or mobile application that is executed using a computing system. FIG. 15 is a schematic block diagram of an example computing system 1500. The example computing system 1500 includes at least one computing device 1502. In some embodiments the computing system 1500 further includes a communication network 1504 (such as the internet or a cellular network) and one or more additional computing devices 1506 (such as a server).

Computing device 1502 can be, for example, a smart phone or other mobile device, a tablet computing device, a netbook, a computing device located in a user's home or in a care provider's office, or any other computing device. Computing device 1502 can be a stand-alone computing device or a networked computing device that communicates with one or more other computing devices 1506 across network 1504. Computing device 1506 can be, for example, located remote from computing device 1502, but configured for data communication with computing device 1502 across a network 1504. Computing device 1506 can be, for example, a server.

In some examples, the computing device 1502 or 1506 includes at least one processor or processing unit 1508 and system memory 1510. Depending on the exact configuration and type of computing device, the system memory 1510 may be volatile (such as RAM), non-volatile (such as ROM, flash memory, etc.) or some combination of the two. System memory 1510 typically includes an operating system 1512 suitable for controlling the operation of the computing device, such as the WINDOWS® operating systems from Microsoft Corporation of Redmond, Washington or a server, such as Windows SharePoint Server, also from Microsoft Corporation. To provide further example, if the computing device 1502 is a smart phone or other mobile device, the operating system 1512 may be iOS, WP7, or any other available mobile operating system. The system memory 1510 may also include one or more software applications 1514 and may include program data 1516. The software applications 1514 may be in the form of mobile applications in examples wherein the computing device 1502 is a mobile device.

The computing device 1502 may have additional features or functionality. For example, the device may also include additional data storage devices 1518 (removable and/or non-removable) such as, for example, magnetic disks, optical disks, or tape. Computer storage media 1518 may include volatile and nonvolatile, removable and non-removable media implemented in any method or technology for storage of information, such as computer readable instructions, data structures, program modules, or other data. System memory, removable storage, and non-removable storage are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing device. An example of computer storage media 1518 is non-transitory media. The computing device 306 may include data storage media such as the data storage media 1518 described above, on which game data is stored.

In some examples, one or more of the computing devices 1502, 1506 can be a smart phone or other mobile device. FIG. 15 includes a schematic diagram of such device. The computing device 1502 may be a smart phone or other mobile device with input device options including, but not limited to, a keypad 1520, a screen 1522, a touch screen controller 1524, and/or a touch screen 1526. In other examples, the computing device can be a personal computing device that is networked to allow the user to access the system disclosed herein at a remote location, such as in a user's home, office or other location. In some embodiments, components of the system are stored as data instructions for a smart phone application. A network 1504 facilitates communication between the computing device 1502 and one or more servers, such as computing device 1506, that host the system disclosed herein. The network 1504 may be a wide variety of different types of electronic communication networks. For example, the network may be a wide-area network, such as the Internet, a local-area network, a metropolitan-area network, a cellular network or another type of electronic communication network. The network may also be a cellular network in some embodiments. The network may include wired and/or wireless data links. A variety of communications protocols may be used in the network 1504 including, but not limited to, Ethernet, Transport Control Protocol (TCP),

Internet Protocol (IP), Hypertext Transfer Protocol (HTTP), SOAP, remote procedure call protocols, and/or other types of communications protocols.

In some examples, computing device 1506 is a Web server. In this example, computing device 1502 includes a Web browser that communicates with the Web server to request and retrieve data. The data is then displayed to the user, such as by using a Web browser software application. In some embodiments, the various operations, methods, and rules disclosed herein are implemented by instructions stored in memory. When the instructions are executed by the processor of one or more of computing devices 1502 and 1506, the instructions cause the processor to perform one or more of the operations or methods disclosed herein. Examples of operations include assigning homework, completing homework assignments or games, and sending or receiving feedback.

Further, the computing device 1502 may include image capture devices, whether a dedicated video or image capture device, smart phone or other device that is capable of capturing images and video. Further, the system may include smart phones with native or web-based applications that can capture, store and transmit time-stamped video and images to a central server. The system and method can also include location-data captured by a GPS-enabled application or device. The computing device 1502 may also have WiFi or 3G capabilities.

The various embodiments described above are provided by way of illustration only and should not be construed to limit the claims attached hereto. Those skilled in the art will readily recognize various modifications and changes that may be made without following the example embodiments and applications illustrated and described herein and without departing from the true spirit and scope of the following claims.

What is claimed is:

1. A mobile therapy system comprising:
a database configured to store therapy application data and patient data;
a display configured to display therapy data and receive patient input regarding mental or emotional state;
a processor configured to provide therapy application data based on a programmed command or a care provider command; and
a communication means for communicating patient data to a care provider and for receiving care provider commands.

2. The system of claim 1, wherein the processor is configured to program itself to provide a certain therapy application based on the time or the patient's location.

3. The system of claim 1, wherein the processor is configured to program itself to communicate with the care provider based on the time or the patient's location.

4. The system of claim 1, wherein the processor is configured to communicate to the care provider the date, time, and location that the patient interacted with a therapy application.
